(19) United States
(12) Patent Application Publication
(10) Pub. No.: US 2019/0135340 A1
(43) Pub. Date: May 9, 2019

(54) ROLL INDUCED FOUR WHEEL STEERING VEHICLE

(71) Applicant: Michael John Mainville, Saint Augustine, FL (US)

(72) Inventor: Michael John Mainville, Saint Augustine, FL (US)

(21) Appl. No.: 15/804,046

(22) Filed: Nov. 6, 2017

(51) Int. Cl. B62D 9/02; B60G 7/02; B60G 15/06

(52) U.S. Cl. CPC B62D 9/02; B60G 7/02; B60G 15/067; B60G 2300/124; B60G 2200/10; B60G 2500/42; B60G 2800/012

(57) ABSTRACT

The roll induces four wheel steering vehicle employs a frame system to protect the driver and serves as an attachment point for, independent suspension links pivotally connect to the wheel assemblies enabling four wheel independent suspensions. A mechanically manipulated centrally mounted steering and suspension pivot, provides both steering control and suspension attachment for the shock and spring. The device is controlled by the driver using typical steering wheel and pedal movement. Steering movement by the driver produces proportionally appropriate camber, steering angle, and roll simultaneously. The invention provides a feeling of integration with the vehicle as the driver rolls into turns with the vehicle, while minimizing fatigue caused by the continuous resistance to centrifugal cornering forces.

### FIELD OF THE INVENTION

The invention relates to a vehicle providing four wheel steering, four wheel independent suspensions, and proportional roll during cornering resulting in an improved driver comfort over adverse terrain.

### BACKGROUND OF THE INVENTION

Having become very popular, utility task vehicles or UTV's for short are typically used for recreation or transportation. They can be combustion engine or electrically driven. UTV's typically feature 4 large air filled rubber tires. A typical UTV has independent suspension, although some may feature solid axles. Most UTV's rely on front wheel steering similar to what is found in an automobile. They are well documented in the art.

Prior art design UTV's have provided adequate performance over rough surfaces, or smooth turns, but can be uncomfortable when rough surfaces are encountered while turning or when turning sharply at high speed. Centrifugal forces developed during such a turn cause the vehicle to roll outward from the direction of the turn, creating unwanted sway. As a countermeasure, it is common practice in prior art designs to add sway bars to minimize this roll effect on the vehicle. This has a negative translation effect allowing bump forces from one side of the vehicle to the other. Furthermore; no countermeasure exists to assist the driver of the vehicle. Consequently, the driver naturally has a tendency to tilt the head, and lean the body into the turn within the confines of the seat. Although effective, this can become tiring and uncomfortable after some time resulting in fatigue.

The subject invention and embodiments has improved upon the limitations exhibited in prior art, with a different approach. The result is a device that enables the user to navigate all terrain with a feeling of integration, and comfort within the vehicle.

### SUMMARY OF THE INVENTION

The subject invention and embodiments comprises of a method and apparatus for a four wheel roll steering device with four wheel independent suspension. The invention may be combustion engine or electrically driven. The invention employs a frame system and independent suspension links, pivotally connected to the wheel assemblies. Furthermore, the subject invention and its embodiments are supported by a manipulated centrally mounted steering and suspension pivot, providing both steering control and suspension attachment for the shock and spring. By intentionally rolling the entire chassis of the vehicle into the turn, centrifugal forces experienced by the driver are directed downward, resulting in a feeling of integration and comfort even in adverse terrain.

### BRIEF DESCRIPTION OF THE DRAWINGS

These and other features and advantages of the present invention and other embodiments will become more readily appreciated as the same becomes better understood by reference to the following detailed description when considered in the connection with the accompanying drawings within. These drawings are for the purpose of illustration and not to be in any way limiting:

FIG. 1 is a perspective view of the vehicle;

FIG. 2 is a partial view of the suspension and steering components, without the wheel assemblies;

FIG. 3 is a simplified diagram of the suspension and steering components, illustrating the pivot points and how the suspension would look during non-compressed level stance;

FIG. 4 is a simplified diagram of the suspension and steering components, illustrating the pivot points and how the suspension would look during compression level stance;

FIG. 5 is a simplified diagram of the suspension and steering components, illustrating the pivot points and how the suspension would look during non-compressed turning resulting from roll initiated by the driver;

FIG. 6 is a simplified view from above illustrating one embodiments angular movement of each wheel as the vehicle is rolled into a turn;

FIG. 7 is a block diagram illustrating how one embodiment would look with its individual components would interconnect to provide a functional system;

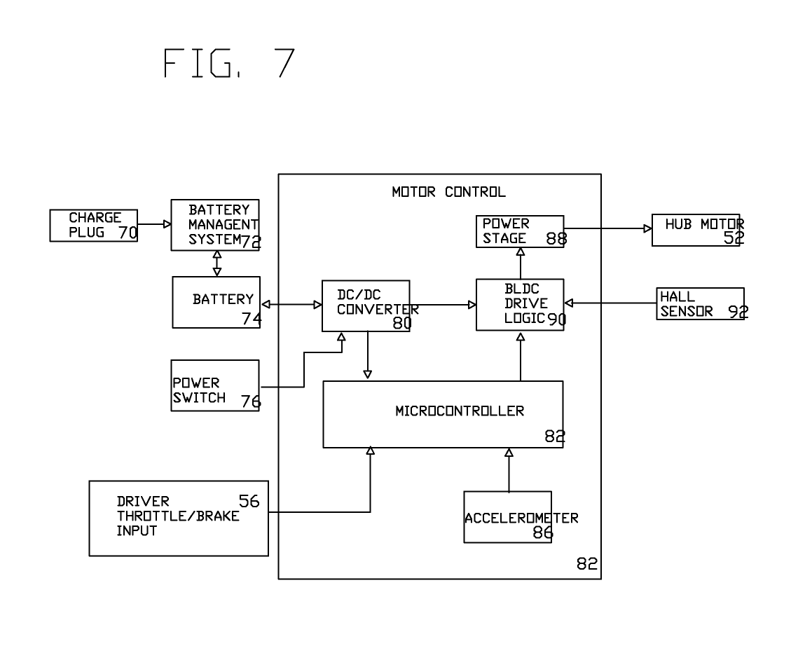

### DETAILED DESCRIPTION OF THE DISCLOSURE

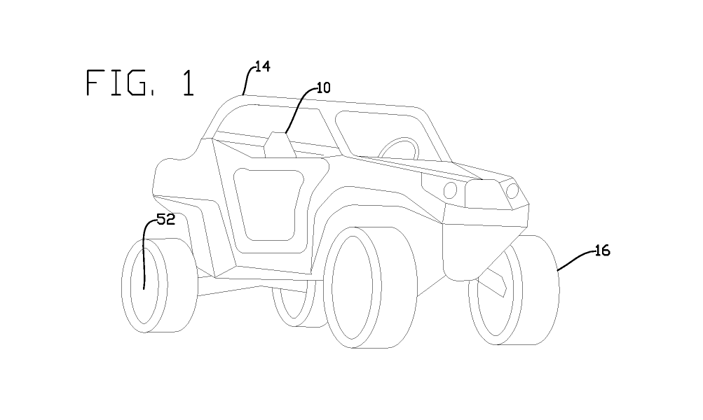

FIG. 1 illustrates perspective view of one embodiment of the invention constructed in accordance with teachings of the present invention. This device can be used for entertainment, sport, or transportation. When operating this device, the driver climbs inside the driver's seat in the cockpit 10, and grabs hold of the steering wheel 24; both roll and steering are accomplished by turning steering wheel in the direction of the turn. Speed or braking commands are generated by foot controlled accelerator and brake as is common practice in the art. The illustrated device consists of a frame 14 providing attachment points for mechanical components as well as a safety cage for the driver. The ground contacting element 12 is rotated by a single sided hub motor 52 contained within the wheel. Each wheel is able to move up and down independently to provide controlled suspension over adverse terrain.

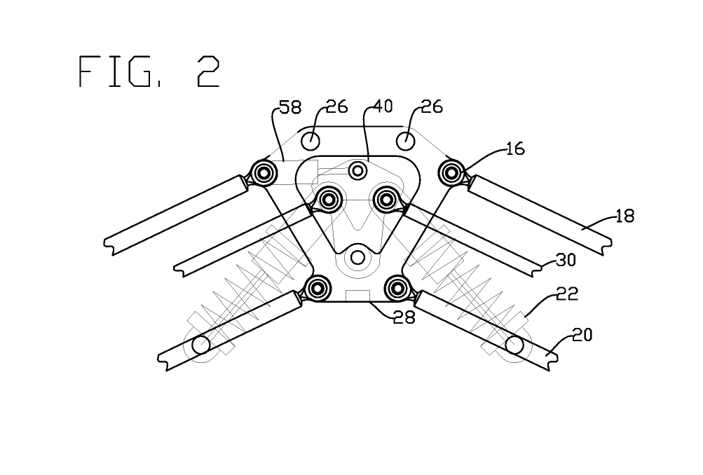

FIG. 2 is a partial view of the front of the device illustrating how the upper 26 and lower 28 frame rails are positioned by the frame support and suspension pivot mounting plate 64. Four rails would be made of metal tubing; which would be welded to eight mounting plates 64. Four in the front of the device and four in the rear, to creating a solid mounting structure for suspension components. The upper 18 and lower 20 suspension links are pivotally connected to the mounting plates 64 using rod end bearings 16. The other end of the suspension links 18, 20 are pivotally connected to the wheel assembly not shown in this figure. The centrally mounted steering mechanism 40 is located along the longitudinal centerline of the frame. This mechanism is pivotally attached to the mounting plates using a long cap screw and thrust washers. Pivotally connecting between the centrally mounted steering mechanism 40 and the lower suspension link 20 is a shock absorber with spring 22. Further attached to the same point is a pivotally attached tie rod 30 via rod end bearing 16. Mounted to the top of the upper frame rails 26 and above the centrally mounted pivot mechanism 40 is a electrically driven linear actuator 58. The actuator is used to roll the chassis about its longitudinal axis by pushing on the centrally mounted pivot mechanism. This action also creates changes in camber. The actuator is only mounted at the front of the vehicle, and is not necessary on the rear pivot although other embodiments may include such a feature. Steering responsiveness can be altered by changing the ratio of front to back steering action. Typically, it is desirable to have sharper steering in the front of the vehicle than the rear. By adjusting the tie rod mounting position on the spindle, the preferable balance between stability and agility can be found.

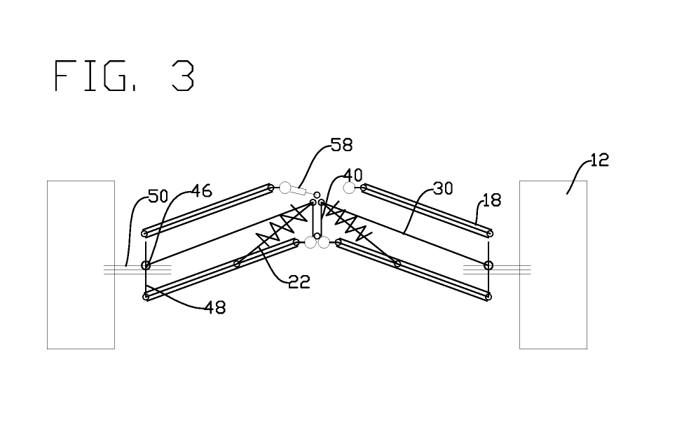

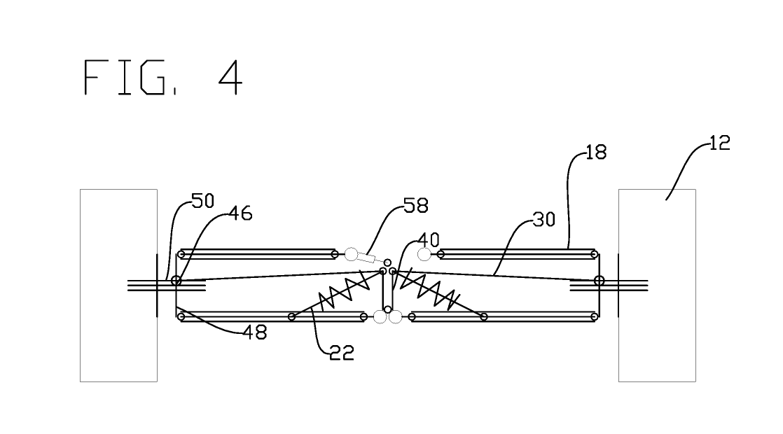

FIG. 3 and FIG. 4 are simplified diagrams to illustrate suspension movement during two stages of compression. As the control links 18, 20 move up and down through equal compression of the suspension, the shock and spring 22 becomes compressed. The centrally mounted steering mechanism remains in the vertical position producing no steering reaction to the tie rods 30, only slight toe-in and toe-out movement will be exhibited depending on the suspension dynamics of the particular embodiment.

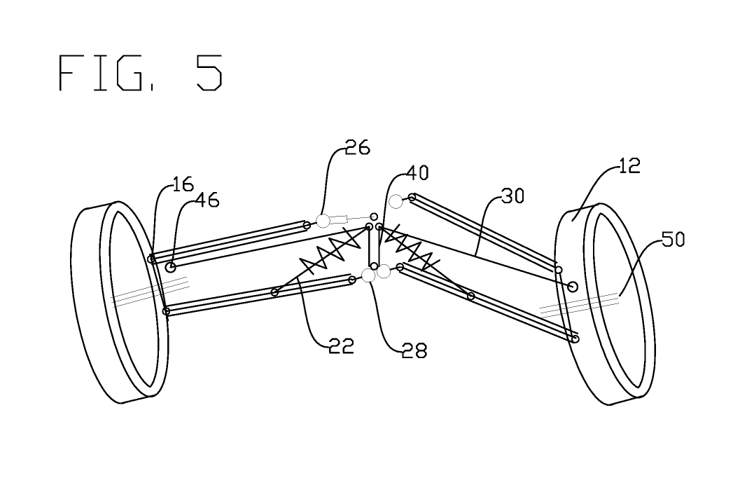

FIG. 5 illustrates the movements that occur when a driver rolls the device by turning the steering wheel thereby producing changes in suspension geometry. The upper frame rail 26 provides a pivotal mounting location for the upper control arm 18 by means of a rod end bearing 16. The lower frame rail 28 provides both a mounting locations for the lower control arm 20 by means of a rod end bearing 16, and the center steering and suspension pivot 40 by means of a bushing bearing and the mounting plate. The tie rods 30 connect between the spindle steering knuckle 46, and the center steering and suspension pivot 40, via rod end bearings. The upper mounting bolt of the coil over shock absorber 22 performs double duty as a mounting location for the tie rod ends. The lower end of the coil over 22 shock mounts to the lower a-arm 20. The spindles are attached to the upper 18 and lower 20 a-arms via ball joints 48. When the vehicle is rolled left or right, it produces an axial rotation about the longitudinal axis of the chassis. The upper frame rail 26 moves either up or down with respect to the horizon depending on the axial rotation. This movement produces proportional camber changes depending on the degree of rotation. It does not; however produce a change in rotation of the center steering and suspension pivot, due to equalization of forces through the movable coil over shock absorber 22. The fact that the center steering and suspension pivot remains unchanged in the vertical plane is the key to the steering mechanism. Since the length of the tie-rod 30 is constant as well as the orientation of the center steering and suspension pivot 40, but the distance to the steering knuckle 46 changes due to camber change induced by axial rotation, the result is to push and pull on the movable steering knuckles 46. This pushing and pulling action on the steering knuckle 46 is what is responsible for the steering of the vehicle. The reverse is realized when rolling occurs in the opposite direction. This can be seen in the diagram by comparing the steering knuckle 46 position, with regards to the center line of the ball joints 48. In this embodiment the diagram shows how this position would move fore and aft of the centerline during turning.

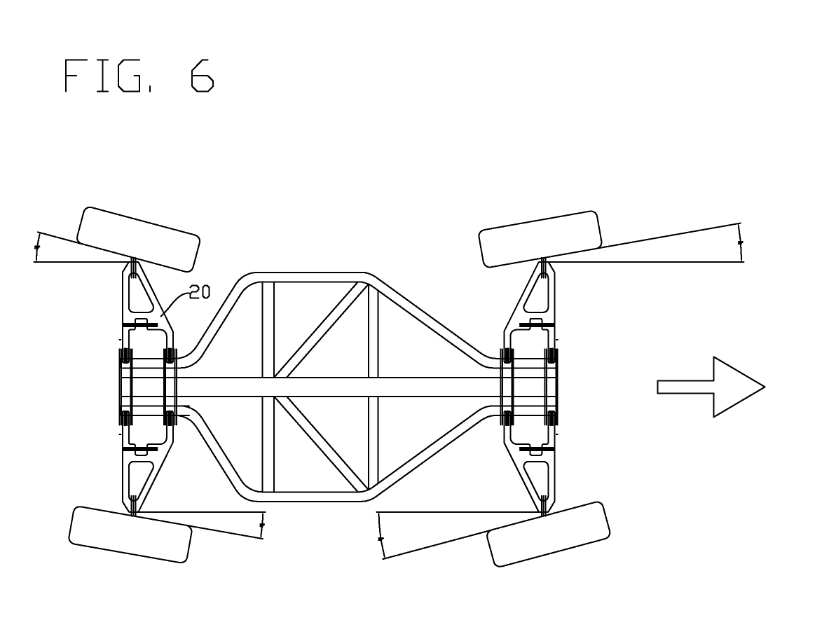

FIG. 6 illustrates how turning the steering wheel creates different steering movements depending on the wheels location. Turning the steering wheel to the left causes the front left wheel 32 to roll and rotate slightly to the left. The front right wheel 34 rolls the same direction, but rotates further to the left than the front left wheel. Steering to the left also causes the left rear wheel 36 to roll and rotate heavily to the right. The right rear wheel 38 also rolls the same direction, but rotates less to the right than the rear left wheel 36. The amount of rotation as well as the difference in rotation is shown for this embodiment; however this can also be adjusted by an increase or decrease in the length of the centrally mounted steering arm to change steering characteristics. The front wheel steering works counter to the Ackerman principle. The rear wheels follow the Ackerman principle. Given that the circumference of the path traced by the wheel is smaller on the inside wheel than the outside wheel, the resulting turning radius of the inside wheel should be shorter than the outside wheel. This principle aims to reduce tire wear on a vehicle by steering the inside wheel more than the outside wheel. In practice however, it has been found that vehicle being encountering mud and sand, results in the inside front wheel depositing this debris, into the cockpit 10, arms and face of the driver. This is an undesirable effect for the driver of such a vehicle. By reducing the turning action of the inside front wheel, and increasing the turning action of the outside wheel, this effect is greatly reduced. The same steering system being mounted in reverse on the rear of the vehicle produces results consistent with the Ackerman principle, since dirt and debris are not of concern on the rear wheels because the debris is thrown to the rear of the vehicle behind the driver.

FIG. 9 is a block system diagram of the embodiment. The charge plug 70 provides DC voltage to the battery management system 74. The battery management system balances the individual cells of the battery 74, as well as controlling charge current, discharge current, maximum voltage, and cutoff voltage. A power switch 76 mounted on the enclosure enables the system. The microcontroller 82 receives power from the DC/DC converter 80, and input signals from the accelerometer 56 and the acceleration and brake signal. The microcontroller 82 outputs velocity commands to the BLDC drive logic 90. These commands are calculated by a combination of inputs from the driver acceleration and braking inputs, and the accelerometer 86. The driver produces the acceleration or braking actions to be used as analog voltage velocity commands to the BLDC logic. A mathematical algorithm utilizing orientation data from the accelerometer 86 would add or subtract proportional analog voltage velocity commands to the left or right side BLDC motor controllers to aid in turning. Reduced velocity on the inside wheel during a cornering situation than the outside wheel would produce additional turning effectiveness. Additionally, pitch information from the accelerometer 86 would aid in smoothing acceleration and braking, and level the vehicle during jumping if desired. The power stage 88 supplies the voltage and current to the hub motor 52. Hall sensors 92 mounted inside the hub motor 52 provide velocity feedback and angular motor phasing information for the BLDC drive logic 90.

The invention has been described in an illustrative manner, and it is to be understood that the terminology which has been used is intended to be in the nature of the words of description rather than a limitation. Obviously, many modifications and variations of the preferred embodiment are possible in light of the above teachings. For example one embodiment may include a cantilevered shock assembly. Another example of an embodiment may include suspension links of different lengths. Yet another may have a variation of plates mounted to the frame if any. Yet another may have a simple chain and sprocket, steering box, or rack and pinion to manipulate the centrally mounted steering mechanism. Yet another might simply be a rolling device void of any motors, electrical system whatsoever. It is therefore, to be understood that within the scope of the below claims, the invention may be practiced otherwise than as specifically described. The invention is defined by the claims.

What is claimed is:

1) A roll induced four wheel steering vehicle comprising:
a) A rigid chassis;
b) A plurality of resilient shock absorbers pivotally connected between a plurality of suspension links and said chassis;
c) A plurality of wheel assemblies including ground contacting elements pivotally connected to said suspension links and disposed at opposite ends of the chassis;
d) A plurality of centrally mounted steering mechanisms which can be mechanically manipulated, whereby transversely mounted tie rods, and coil over shock absorbers are pivotally connected to the upper portion of said centrally mounted steering mechanisms said centrally mounted steering mechanism being transversely and pivotally connected to a lower mounting position.

2) The device in claim 1, where at least one wheel assembly includes one or more electrically driven single sided hub motors.

3) The device in claim 2, where at least one motor is internally geared.

4) The device in claim 2, where at least one motor is directly driven.

5) The device in claim 1, where all wheels driven using and internal combustion engine.

6) The device in claim 1, where the wheel assemblies include free rolling wheels.

7) The device in claim 1, where said rigid continuous chassis provides mounting points for said suspension links and said centrally mounted steering mechanism.

8) The device in claim 1, where said rigid chassis is non-continuous and provides securing means and mounting points for said suspension links and said centrally mounted steering mechanism.

9) The device in claim 1, where coil over spring shock absorbing devices are transversely mounted, and attached to a centrally mounted steering mechanism.

10) The device in claim 1, where a centrally mounted steering mechanism pivots, induced mechanically thereby generating steering response.

11) The device in claim 1, further provides greater steering response to the outside wheel on the front of said device, and greater steering response to the inside wheel on the rear of said device during turning, thereby minimizing debris effecting driver of the vehicle.

12) The device in claim 2, where an enclosure containing electrical power and control devices is mounted to said rigid chassis in such a manner as to utilize the enclosure for additional chassis strengthening, additionally said chassis is perimeter mounted, creating a protective cage around said enclosure to prevent damage from debris and impacts.

13) The device in claim 1, further where a centrally mounted steering mechanism is manipulated by a linear actuator, reduction gear box, rack and pinion, or any other actuation device.

14) The device in claim 2, where at least one accelerometer measures the roll angle, and creates a differential in the velocity command signal for the motor drives resulting in either slowing of the front and rear wheels on the side of the deck that is tilted down during a turn, or accelerates front and rear wheels on the side of the deck that are tilted up during a turn, or combination thereof enhancing turning capability.

15) The device in claim 1, wherein said wheel assemblies are utilized by rotation or counter-rotation to provide attitude adjustment by means of gyroscopic effect in response to accelerometer inputs, when the vehicle is in the air.
